(19) United States
(12) Patent Application Publication
(10) Pub. No.: US 2014/0141952 A1
(43) Pub. Date: May 22, 2014

(54) METHODS AND APPARATUS FOR FORMING A REINFORCED TRAY

(71) Applicant: ROCK-TENN SHARED SERVICES, LLC, Norcross, GA (US)

(72) Inventors: Thomas Dean Graham, Winter Garden, FL (US); Amer Aganovic, Orlando, FL (US)

(73) Assignee: ROCK-TENN SHARED SERVICES, LLC, Norcross, GA (US)

(21) Appl. No.: 13/827,466

(22) Filed: Mar. 14, 2013

Related U.S. Application Data
(60) Provisional application No. 61/728,686, filed on Nov. 20, 2012.

(51) Int. Cl. B31B 1/00

(52) U.S. Cl. CPC B31B 1/00
USPC 493/148

(57) ABSTRACT

An apparatus for forming a container is provided. The apparatus includes a hopper station including a hopper assembly configured to store a plurality of blanks and retrieve a single blank from the plurality of blanks, and a blank feeder assembly including a plurality of tab bullets each configured to fold a respective stacking tab of the blank. The apparatus further includes a laminating station downstream from the hopper station and configured to laminate at least a portion of the container, and a compression station downstream from the laminating station, the compression station configured to form at least one corner wall of the container.

### CROSS REFERENCE TO RELATED APPLICATIONS

This application claims priority to U.S. Provisional Application No. 61/728,686 filed Nov. 20, 2012, which is hereby incorporated by reference in its entirety.

### BACKGROUND OF THE INVENTION

The embodiments described herein relate generally to a machine for forming a container from sheet material, and more particularly to a machine for automatically forming a tray that includes reinforced side walls and corner structures.

Containers fabricated from paperboard and/or corrugated paperboard materials are often used to store and transport goods. These containers can include four-sided containers, six-sided containers, eight-sided containers, bulk bins and/or various size corrugated barrels. These containers may be stacked atop one another for storage, transport, and/or display purposes.

Such containers are usually formed from blanks by an apparatus that folds a plurality of panels along preformed fold lines and seals these panels with an adhesive to form an erected corrugated container. Containers may have certain strength requirements for transporting products. These strength requirements may include a stacking strength requirement such that the containers can be stacked on one another during transport, and/or storage and/or display without collapsing. However, if the containers are not properly aligned when stacked or the stacking strength of the container does not meet strength requirements, then the containers may be unstable and collapse.

Accordingly, there is a need for a container that facilitates efficient stacking and meets desired strength requirements, as well as a machine that forms such containers from blank sheet material.

### BRIEF DESCRIPTION OF THE INVENTION

In one aspect, an apparatus for forming a container is provided. The apparatus includes a hopper station including a hopper assembly configured to store a plurality of blanks and retrieve a single blank from the plurality of blanks, and a blank feeder assembly including a plurality of tab bullets each configured to fold a respective stacking tab of the blank. The apparatus further includes a laminating station downstream from the hopper station and configured to laminate at least a portion of the container, and a compression station downstream from the laminating station, the compression station configured to form at least one corner wall of the container.

In another aspect, a method for forming a container is provided. The method includes transporting a blank through a container forming apparatus using a pusher lug, folding at least one stacking tab in a blank feeder assembly using at least one tab bullet, laminating at least a portion of the blank in a laminating assembly, and compressing the blank using a mandrel assembly.

### BRIEF DESCRIPTION OF THE DRAWINGS

FIG. 1 is a top plan view of an exemplary embodiment of a blank of sheet material.

FIG. 2 is a perspective view of a container formed from the blank shown in FIG. 1.

FIG. 3 is a perspective view of two of the containers shown in FIG. 2 in a stacked state.

FIG. 4 is a perspective view of an exemplary container forming apparatus used to form the container shown in FIG. 2.

FIG. 5 is a perspective view of an exemplary hopper assembly of the apparatus shown in FIG. 4.

FIG. 6 is a perspective view of an exemplary blank feeder assembly of the apparatus shown in FIG. 4.

FIG. 7 is a perspective view of an exemplary ledge squaring assembly of the apparatus shown in FIG. 4.

FIG. 8 is a perspective view of an exemplary squaring plate assembly of the apparatus shown in FIG. 4.

FIG. 9 is a perspective view of an exemplary laminating assembly of the apparatus shown in FIG. 4.

FIG. 10 is a perspective view of an exemplary mandrel assembly of the apparatus shown in FIG. 4.

FIG. 11 is a perspective view of a portion of an exemplary compression assembly of the apparatus shown in FIG. 4.

FIG. 12 is a side view of an upstream portion of the exemplary compression assembly shown in FIG. 11.

FIG. 13 is a side view of a downstream portion of the exemplary compression assembly shown in FIG. 11.

### DETAILED DESCRIPTION OF THE INVENTION

The following detailed description illustrates the disclosure by way of example and not by way of limitation. The description clearly enables one skilled in the art to make and use the disclosure, describes several embodiments, presently believed to be the best mode of carrying out the disclosure.

The present invention provides an apparatus for forming a stackable, reinforced container formed from a single sheet of material. The container is sometimes referred to as a reinforced mitered tray or a reinforced eight-sided tray. In one embodiment, the container is fabricated from a paperboard material. The container, however, may be fabricated using any suitable material, and therefore is not limited to a specific type of material. In alternative embodiments, the container is fabricated using cardboard, fiberboard, paperboard, foamboard, corrugated paper, and/or any suitable material known to those skilled in the art and guided by the teachings herein provided. The container may have any suitable size, shape, and/or configuration, whether such sizes, shapes, and/or configurations are described and/or illustrated herein. Further, different embodiments described here can vary in size and/or dimensions. The container may also include lines of perforation for removal of a portion of the container for displaying articles for sale.

The container is sometimes referred to as a reinforced eight-sided tray that is formed by a mandrel driving a partially formed tray through a forming section of the apparatus. The container may be constructed from a blank of sheet material using at least one machine. A blank used for forming the container is described below in detail. Thus the container could be any style of box having mitered corners and stacking tabs.

In an example embodiment, the container includes at least one marking thereon including, without limitation, indicia that communicates the product, a manufacturer of the product and/or a seller of the product. For example, the marking may include printed text that indicates a product's name and briefly describes the product, logos and/or trademarks that indicate a manufacturer and/or seller of the product, and/or designs and/or ornamentation that attract attention. “Printing,” “printed,” and/or any other form of “print” as used herein may include, but is not limited to including, ink jet printing, laser printing, screen printing, giclée, pen and ink, painting, offset lithography, flexography, relief print, rotogravure, dye transfer, and/or any suitable printing technique known to those skilled in the art and guided by the teachings herein provided. In another embodiment, the container is void of markings, such as, without limitation, indicia that communicates the product, a manufacturer of the product and/or a seller of the product.

It should be understood that features included in one embodiment can be used with other embodiments described herein. Further, any of the containers described herein may include handles defined through end and/or side walls thereof. Moreover, vent holes, can be defined through any suitable panel in any of the embodiments and have any suitable size, shape, orientation, and/or location that enable the below-described blanks and containers to function as described herein. Still further, the containers described herein can include adhesives such as, but not limited to, glue, tape and sealing strips which can have any suitable size, shape, orientation, and/or location that enable the below-described blanks and containers to function as described herein.

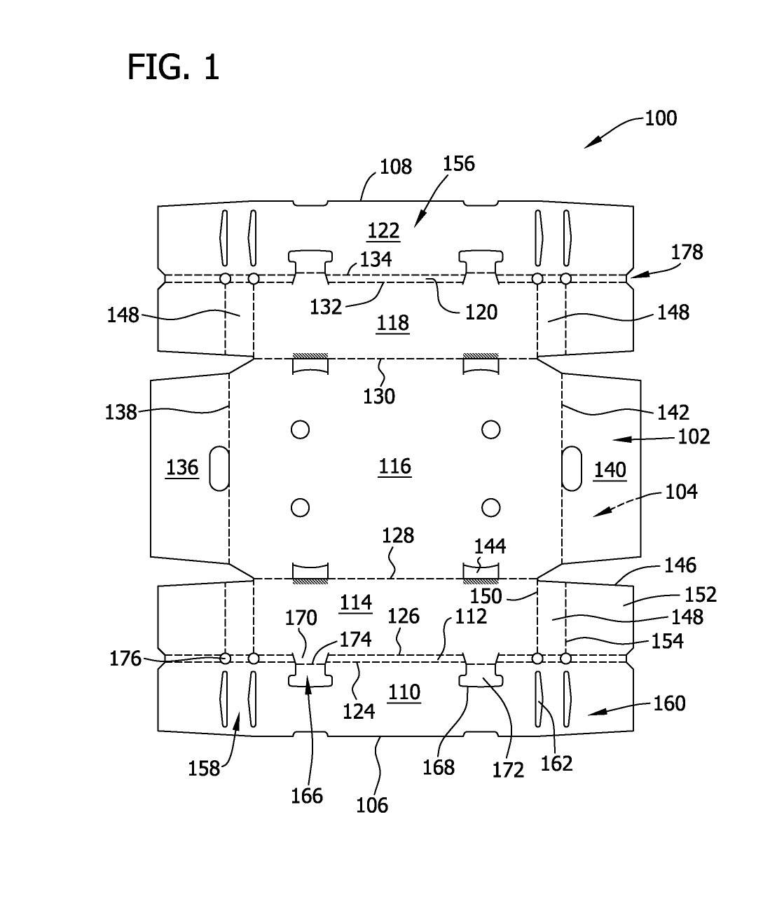

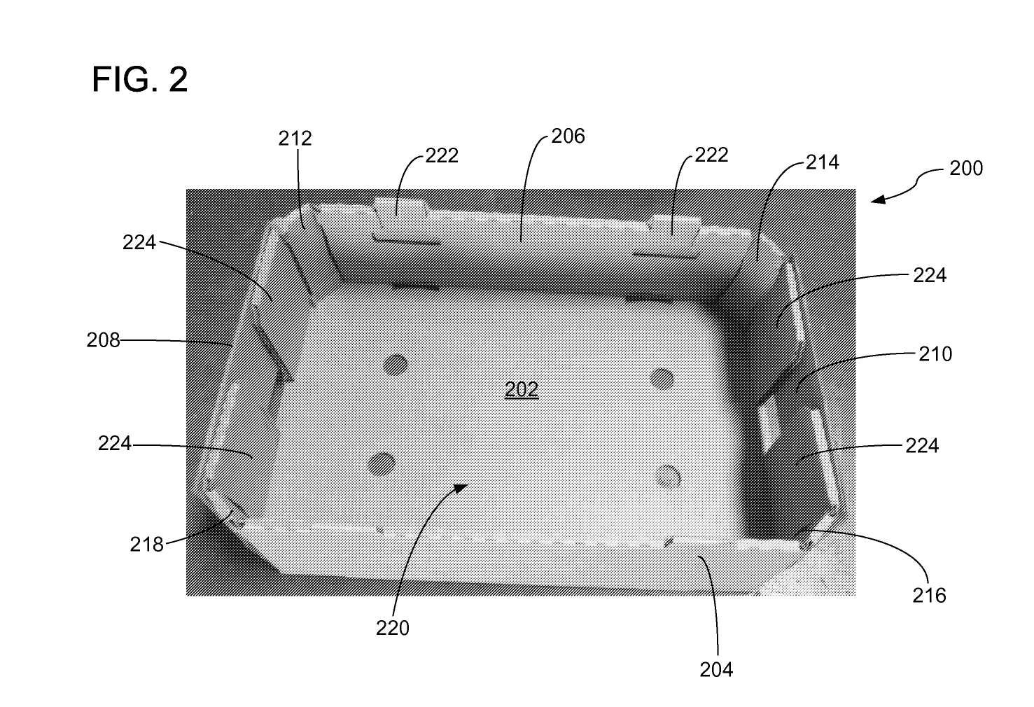

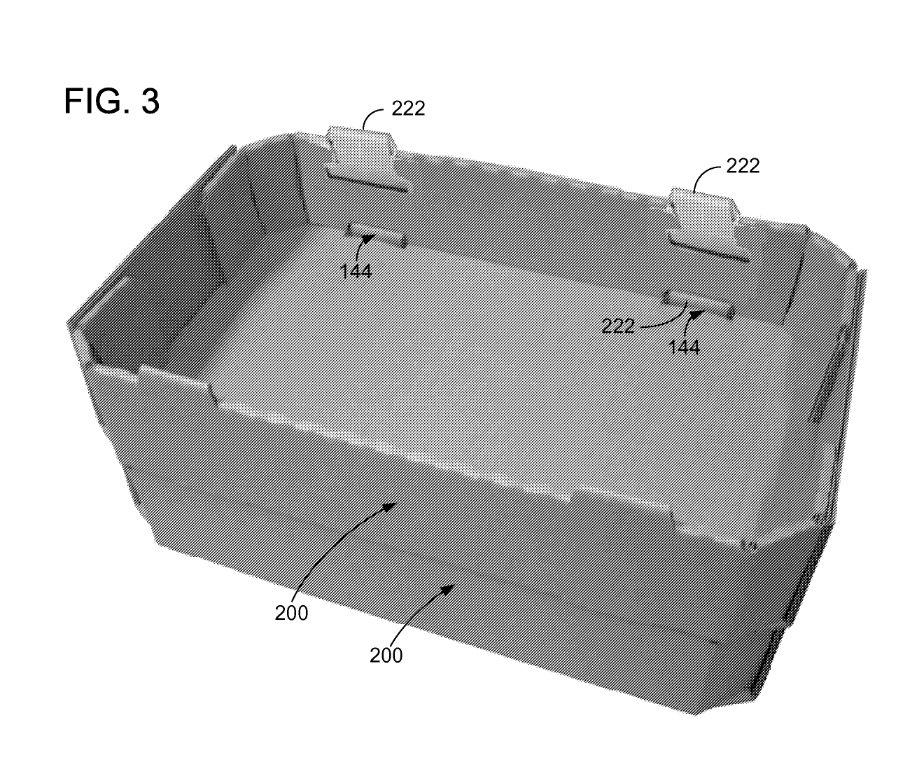

Referring now to the drawings, FIG. 1 is a top plan view of an exemplary blank 100 of sheet material for forming a container 200 (shown in FIGS. 2 and 3). Blank 100 has a first or interior surface 102 and an opposing second or exterior surface 104. Further, blank 100 defines a first edge 106 and an opposing second edge 108. In one embodiment, blank 100 includes, in series from first edge 106 to second edge 108, a first inner side panel 110, a first ledge panel 112, a first outer side panel 114, a bottom panel 116, a second outer side panel 118, a second ledge panel 120, and a second inner side panel 122 coupled together along preformed, generally parallel, fold lines 124, 126, 128, 130, 132, and 134, respectively. Ledge panels 112 and 120 allow for a “true” or “full” rollover.

A first end panel 136 extends from a first end edge of bottom panel 116 along a fold line 138, and an opposing second end panel 140 extends from a second end edge of bottom panel 116 along a fold line 142. In the exemplary embodiment, a pair of slots 144 is defined along each fold line 128 and 130. Slots 144 are configured to receive a stacking tab from a lower container, as described in more detail below.

A reinforced corner assembly 146 extends from each side edge of each outer side panel 114 and 118. As such, blank 100 includes four reinforced corner assemblies 146. Each reinforced corner assembly 146 includes a corner panel 148 extending from a respective outer side panel 114 or 118 at a fold line 150 and an inner end panel 152 extending from a respective corner panel 148 at a fold line 154. Fold lines 150 and 154 are referred to as “miter fold lines”. Miter fold lines 150 and 154 are substantially perpendicular to fold lines 124, 126, 128, 130, 132, and 134.

Each inner side panel 110 and 122 includes a central portion 156, a pair of corner portions 158, and a pair of inner end portions 160. Portions 156, 158, and 160 are continuous portions of material not interrupted by any fold lines. In the exemplary embodiment, a corner portion 158 extends from each side of central portion 156, and an inner end portion 160 extends from each side of each corner portion 156.

An elongated relief cutout 162 is defined between central portion 156 and each corner portion 158 and between each corner portion 158 and each inner end portion 160. As such, each inner side panel 110 and 122 includes four elongated relief cutouts 162. Each elongated relief cutout 162 is generally aligned collinearly with a respective miter fold line 150 or 154. In the exemplary embodiment, each elongated relief cutout 162 is generally oblong-shaped with an apex long one side of the oblong. However, it should be understood that elongated relief cutouts 162 can have any suitable size, shape, and/or configuration that enables blank 100 to function as described herein.

A ledge panel 112 or 120 extends between each corner panel 148 and an adjacent corner portion 158 and between each inner end panel 152 and an adjacent inner end portion 160. A pair of stacking tabs 166 is defined along each ledge panel 112 and 120. More specifically, each tab 166 is defined by a cut line 168 that interrupts fold lines 124 and 126 and fold lines 132 and 134 and extends from an outer side panel 114 or 118 into an adjacent inner side panel 110 or 122. Each tab 166 includes a first portion 170 and a second portion 172 connected by a fold line 174. First portion 170 extends from a respective outer side panel 114 or 118, across ledge panel 112 or 120, into inner side panel 110 or 122. Second portion 172 is defined within a respective inner side panel 110 or 122. In the exemplary embodiment, each tab 166 is aligned with a slot 144.

Further, rollover relief cutouts 176 are defined in each ledge panel 112 and 120. More specifically, a rollover relief cutout 176 is generally aligned between an elongated relief cutout 162 and a respective miter fold line 150 or 154. In the exemplary embodiment, each rollover relief cutout 176 is substantially circular shaped and extends beyond fold lines 124 and 126 or fold lines 132 and 134 into an adjacent panel or portion. However, it should be understood that rollover relief cutouts 176 can have any suitable size, shape, and/or configuration that enables blank 100 to function as described herein. Further, in the exemplary embodiment, relief notches 178 are defined at each ledge panel 112 and 120 such that ledge panels 112 and 120 are narrower than inner side panels 110 and 122 and outer side panels 114 and 118. Cutouts 162 and 176 and notches 178 allow miter fold lines 150 and 154 and cutouts 162 to be substantially perpendicular to fold lines 124, 126, 128, 130, 132, and 134, as opposed to known blanks having miter fold lines that other than perpendicular to at least a bottom panel of the known blank.

FIG. 2 is a perspective view of an exemplary container 200 formed from blank 100 (shown in FIG. 1). Container 200 includes a bottom wall 202, a first side wall 204, a second side wall 206, a first end wall 208, a second end wall 210, and four corner walls 212, 214, 216, and 218 defining a cavity 220. Slots 144 are defined at least in bottom wall 202.

Referring to FIGS. 1 and 2, to form container 200 from blank 100, ledge panel 112 is rotated about fold line 126 toward interior surface 102 of outer side panel 114, and ledge panel 120 is rotated about fold line 132 toward interior surface 102 of outer side panel 118. Similarly, inner side panel 110 is rotated about fold line 124 toward interior surface 102 of ledge panel 112 until inner side panel 110 is substantially parallel to outer side panel 114, and inner side panel 122 is rotated about fold line 134 toward interior surface 102 of ledge panel 120 until inner side panel 122 is substantially parallel to outer side panel 118. At least interior surfaces 102 of central portions 156 of inner side panels 110 and 122 are coupled to interior surface 102 of a respective outer side panel 114 or 118. First outer side panel 114 and central portion 156 of first inner side panel 110 define first side wall 204, and second outer side panel 118 and central portion 156 of second inner side panel 122 define second side wall 206.

Second portion 172 of each tab 166 is rotated about fold line 174 toward a respective first portion 170, and interior surface 102 of second portions 172 are coupled to interior surface 102 of first portions 170 to form a plurality of stacking tabs 222 extending upward from each side wall 204 and 206. The coupling of center portion 156 of inner side panels 110 and 122 to outer side panels 114 and 118, respectively, captures at least a portion of second portion 172 between inner side panel 110 and outer side panel 114 and inner side panel 122 and outer side panel 118.

Each corner panel 148 is in face-to-face relationship with a respective corner portion 158, and each inner end panel 152 is in face-to-face relationship with a respective inner end portion 160. Each corner panel 148 is rotated about a respective fold line 150 toward an adjacent side wall 204 or 206. As such, each corner portion 158 rotates toward an adjacent side wall 204 or 206 at elongated relief cutout 162. Cutouts 162 and/or 176 and/or notches 178 enable corner portions 158 to rotate with respect to central portion 156. Each corner panel 148 and corner portion 158 pair defines a mitered corner wall 212, 214, 216, or 218. In the exemplary embodiment, each mitered corner wall 212, 214, 216, and 218 provide structural strength to container 200.

Similarly, each inner end panel 152 is rotated about a respective fold line 154 toward an adjacent corner wall 212, 214, 216, or 218. As such, each inner end portion 160 rotates toward an adjacent corner wall 212, 214, 216, or 218 at elongated relief cutout 162. Cutouts 162 and/or 176 and/or notches 178 enable inner end portions 160 to rotate with respect to a respective corner portion 158. Each inner end panel 152 and inner end portion 160 pair defines an inner end assembly 224. Inner end assemblies 224 are substantially perpendicular to side walls 204 and 206. In the exemplary embodiment, inner end assemblies 224 are tapered downward as they extend across bottom wall 202 such that side walls 204 and 206 are slightly inclined toward bottom wall 202. The tapering of inner end assemblies 224 transfers any load due to above stacked containers to bottom wall 202 instead of on any adhesive used to couple end assemblies 224 to end panels 136 and 140. Accordingly, tapering inner end assemblies 224 provides container 200 with additional stacking strength and prevents side walls 204 and 206 from collapsing outward.

Each side wall 204 and 206 is rotated about a respective fold line 128 or 130 toward interior surface 102 of bottom wall 202 defined by bottom panel 116. More specifically, side walls 204 and 206 are rotated to be substantially perpendicular to bottom wall 202. As side walls 204 and 206 are rotated, corner walls 212, 214, 216, and 218 and inner end assemblies 224 rotate toward bottom wall 202 to be substantially perpendicular to bottom wall 202.

First end panel 136 is rotated about fold line 138 toward interior surface 102 of bottom wall 202, and second end panel 140 is rotated about fold line 142 toward interior surface 102 of bottom wall 202. A pair of inner end assemblies 224 adjacent to first end panel 136 are coupled to interior surface 102 of first end panel 136 to form first end wall 208. Similarly, a pair of inner end assemblies 224 adjacent to second end panel 140 is coupled to interior surface 102 of second end panel 140 to form second end wall 210.

FIG. 3 is a perspective view of a stack of containers 200. When containers 200 are stacked, stacking tabs 222 of a lower container 200 are received within slots 144 of an upper container 200.

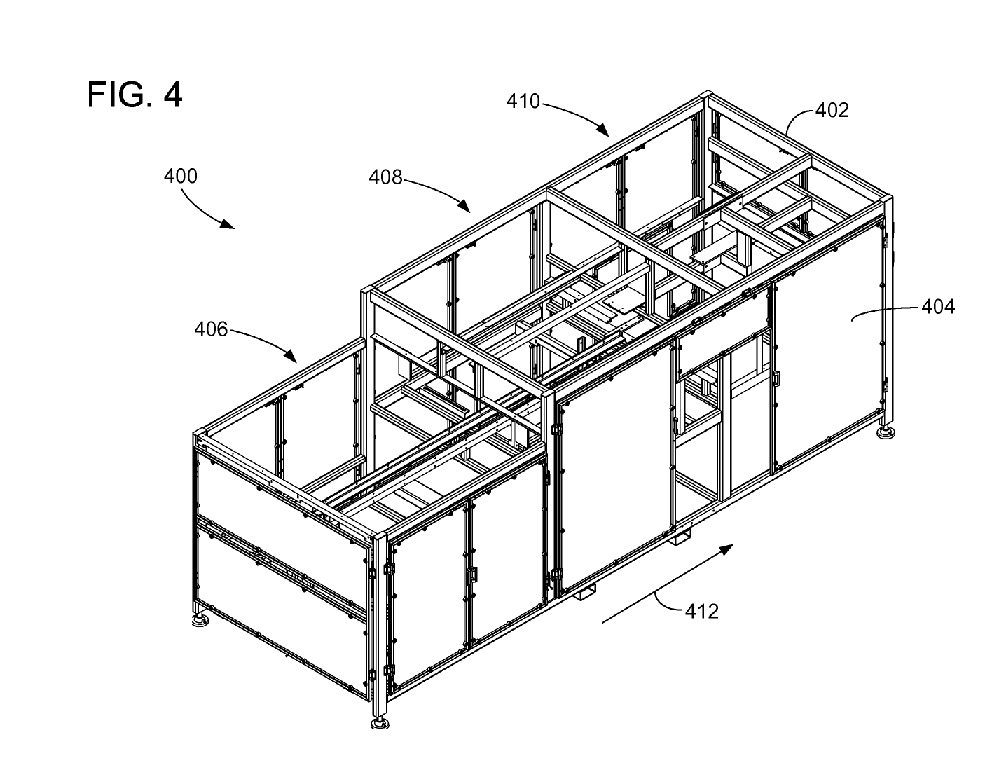

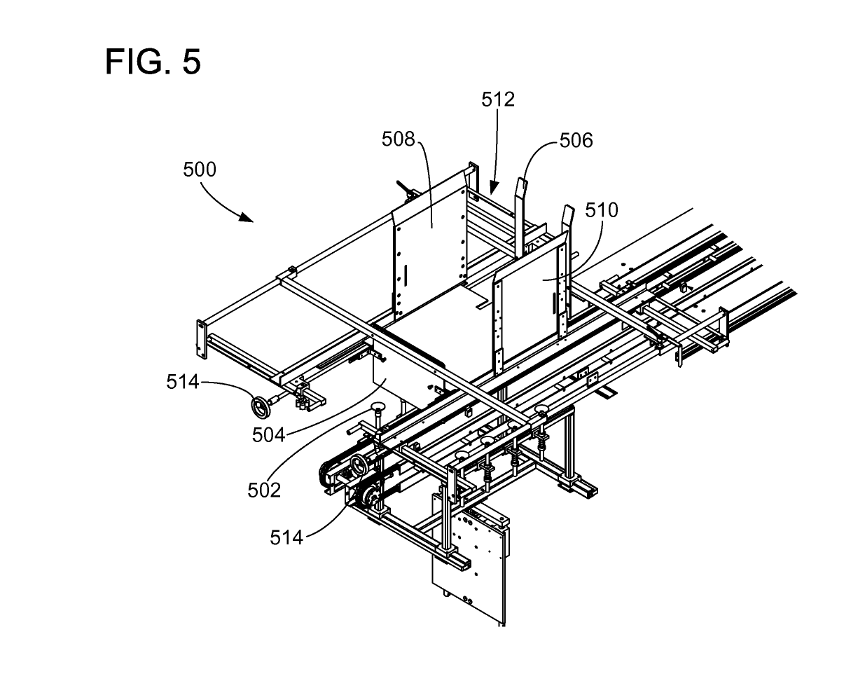

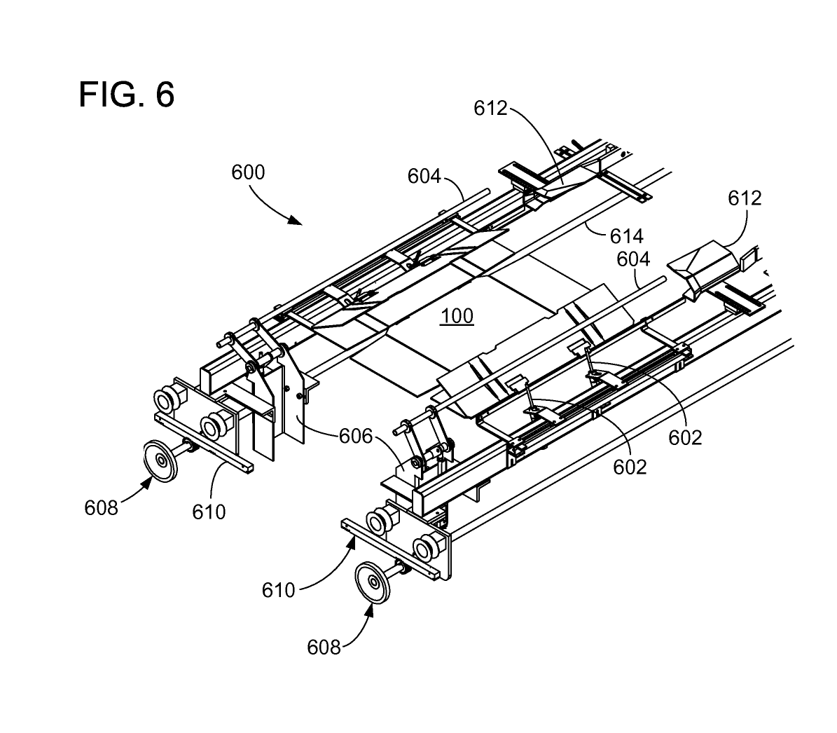

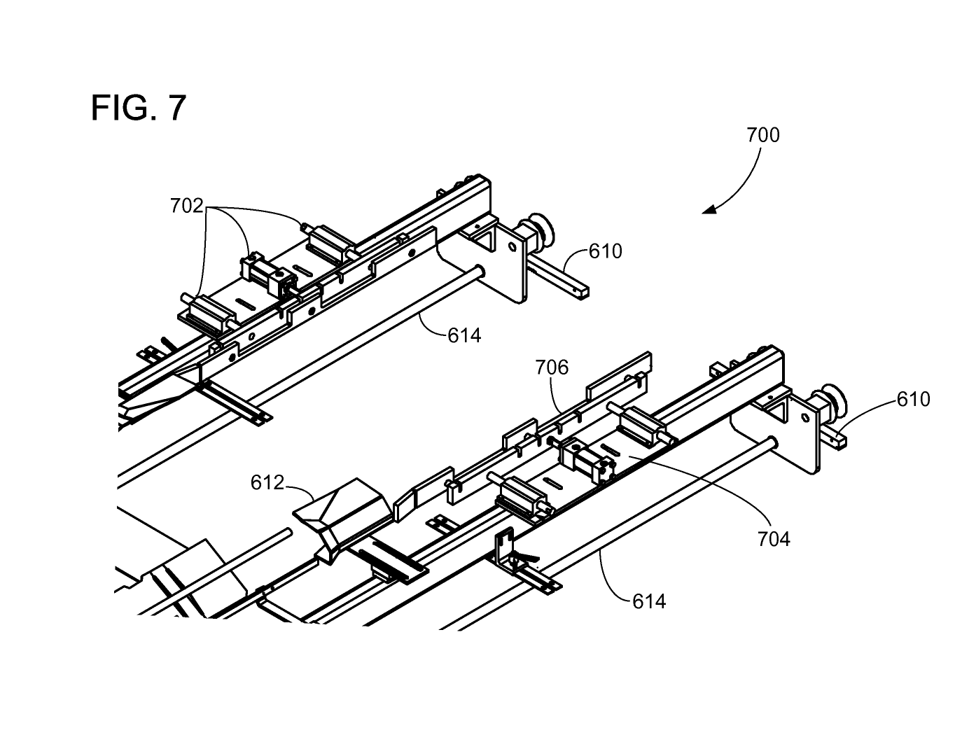

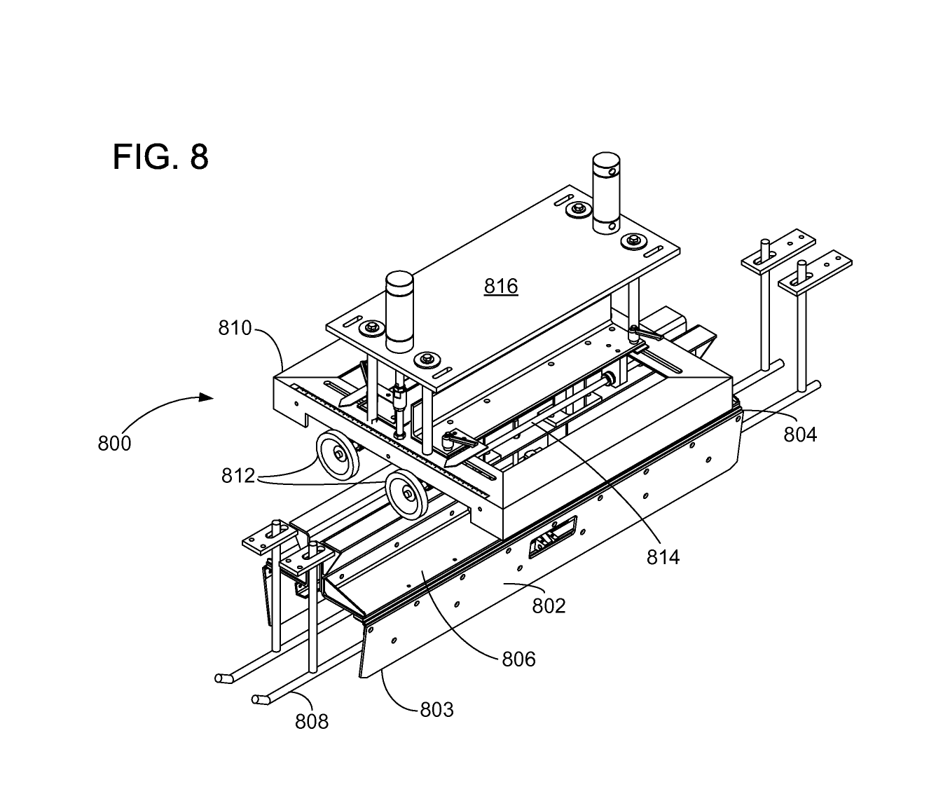

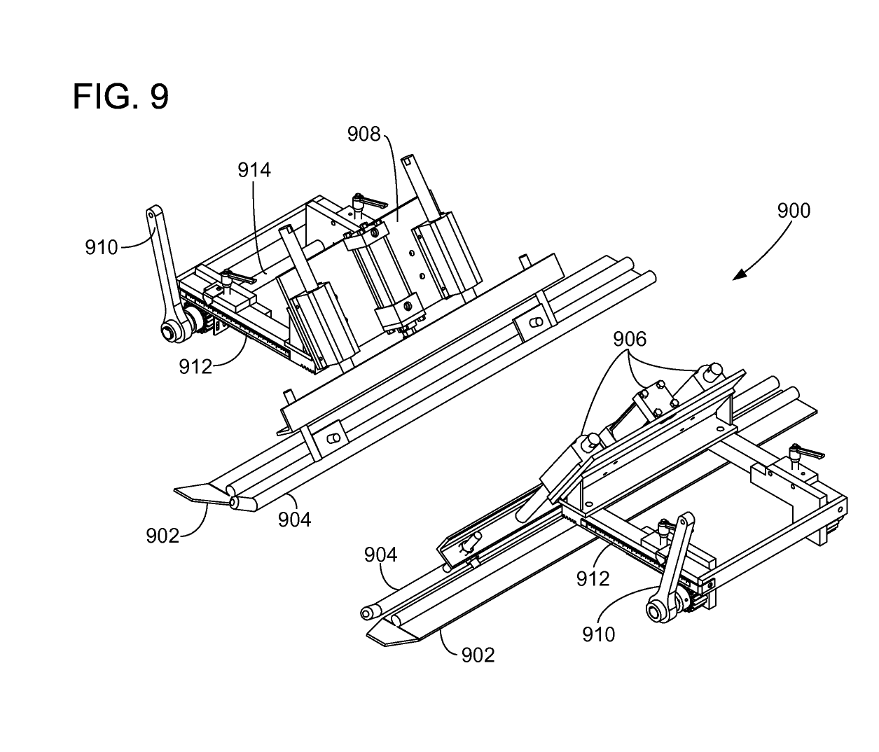

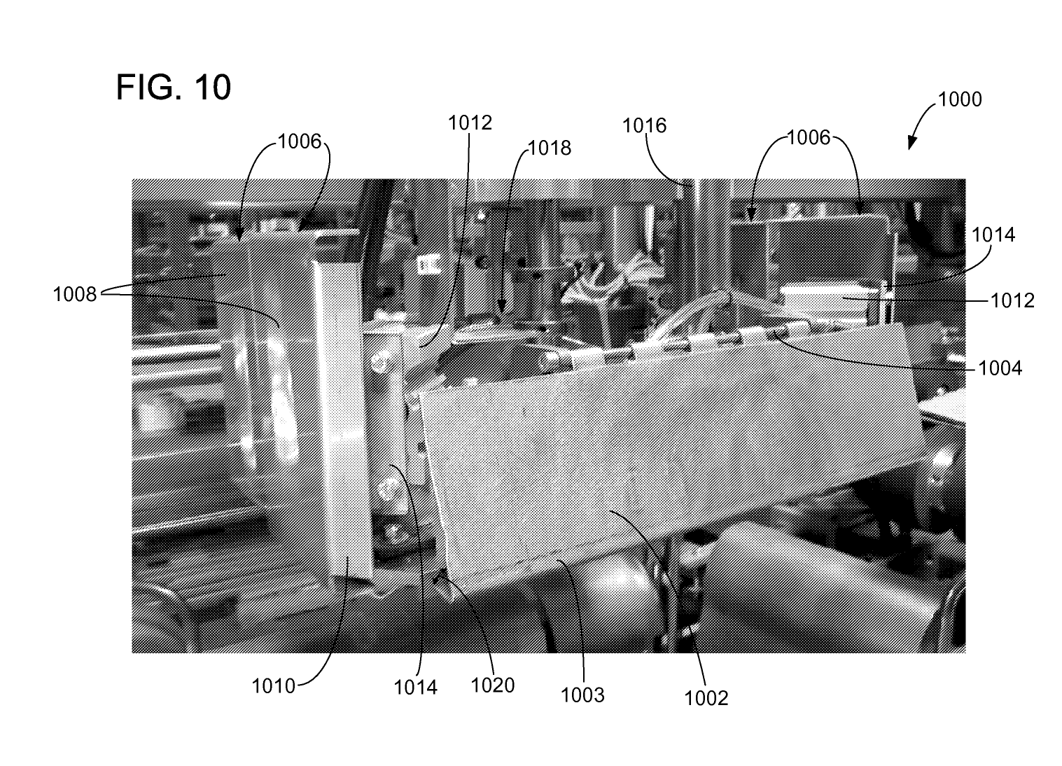

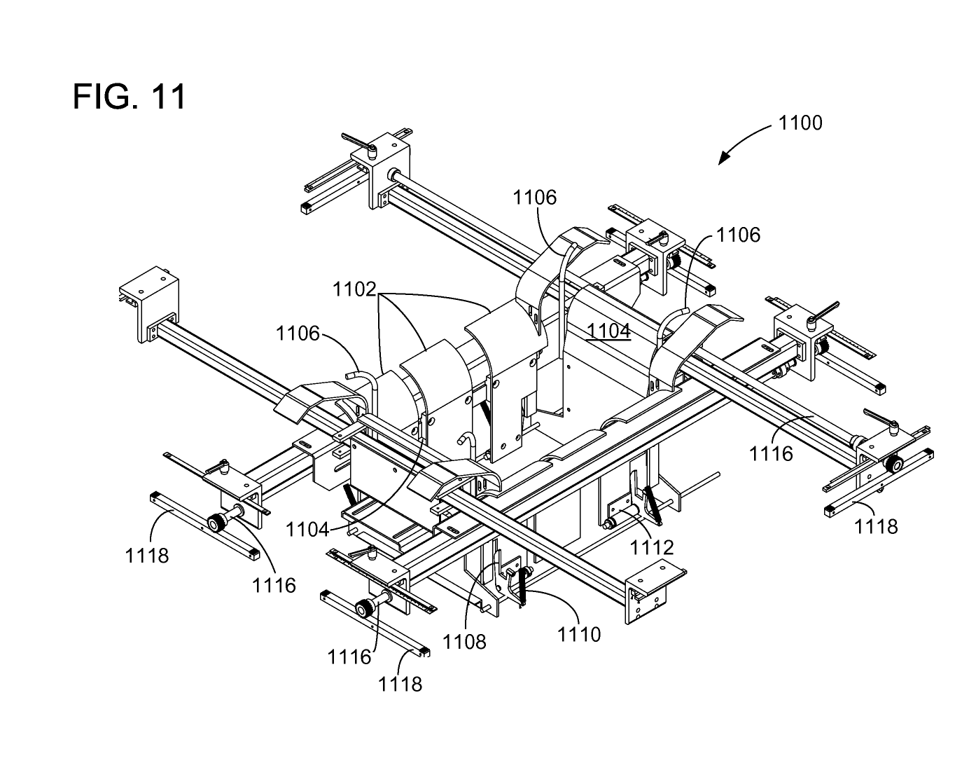

FIG. 4 illustrates an exemplary container forming apparatus 400 for forming blank 100 into fully formed container 200. Container forming apparatus 400 generally includes a hopper station 406, a laminating station 408, and a compression station 410. The hopper station 406 is positioned in the front of apparatus 400 with respect to a direction of arrow 412. Laminating station 408 is positioned downstream of hopper station 406, and compression station 410 is positioned downstream from laminating station 408. Hopper station 406 includes a hopper assembly (shown in FIG. 5) and a blank feeder assembly (shown in FIG. 6). Laminating station 408 includes a ledge squaring assembly (shown in FIG. 7), a squaring plate assembly (shown in FIG. 8), and a laminating assembly (shown in FIG. 9). Compression station 410 includes a mandrel assembly (shown in FIGS. 10, 12, and 13) and a compression assembly (shown in FIGS. 11-13).

Container forming apparatus 400 further includes frame members 402 to which a plurality of protective panels 404 are coupled. Protective panels 404 prevent external objects from interfering with operation of apparatus 400. Protective panels 404 may be made of plastic, glass, and/or any suitable material that facilitates protecting components of apparatus 400. In the exemplary embodiment, protective panels 404 are substantially transparent, enabling an operator to visually monitor operation of apparatus 400.

FIG. 5 shows the exemplary hopper assembly 500 of hopper station 406 of container forming apparatus 400. Hopper assembly 500 includes opposing hopper side walls 508 and 510 and opposing hopper end walls 504 and 506. Side walls 508 and 510 and end walls 504 and 506 are configured to hold a plurality of blanks 100 to be formed into container 200. Hopper assembly 500 further includes a plurality of vacuum cups 502 that are positioned beneath walls 504, 506, 508, and 510 and that are configured to retrieve a single blank 100 from the plurality of blanks 100. Hopper assembly 500 also includes an adjustable rack 512 and at least one hand wheel 514 for adjusting rack 512. In the exemplary embodiment, container forming apparatus is fully adjustable to facilitate formation of containers other than container 200 from blanks other than blank 100. Hand wheel 514 and rack 512 facilitate transition between various blanks.

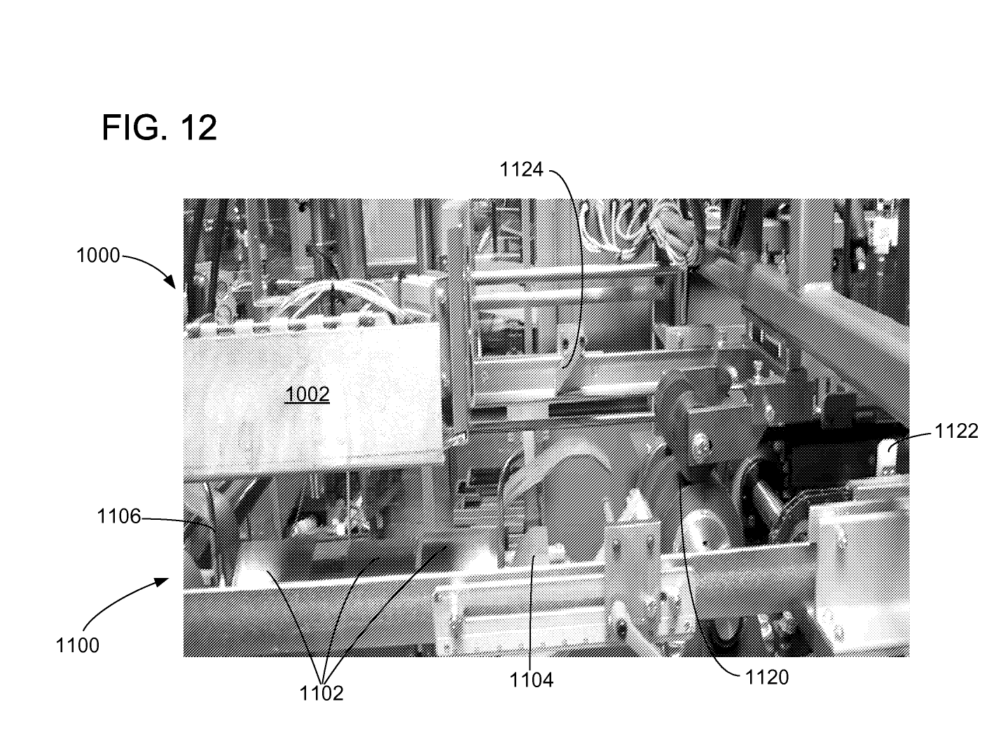

FIG. 6 illustrates blank 100 in the exemplary blank feeder assembly 600 of hopper station 406. Blank feeder assembly 600 includes a plurality of stacking tab bullets 602, at least one side panel rollover arm 604, a rollover arm mount 606, and funnel portions 612. Vacuum cups 502 of hopper assembly 500 are located beneath blank feeder assembly 600 and position blank 100 onto a conveyor system (not shown) after retrieval from hopper assembly 500. A pusher lug (shown in FIG. 12) pushes blank 100 along the conveyor system in the direction of arrow 412 from blank feeder assembly 600 through ledge squaring assembly (shown in FIG. 7), squaring plate assembly (shown in FIG. 8), and laminating assembly (shown in FIG. 9) to compression assembly (shown in FIG. 11). Furthermore, blank feeder assembly 600 includes at least one hand wheel 608, adjustment block 610, and adjustment rail 614. By rotating hand wheels 608 along adjustment blocks 610, container forming apparatus 400 may be modified to accommodate various size blanks.

As the pusher lug pushes blank 100 though blank feeder assembly 600, stacking tab bullets 602 extend to strike and fold inward stacking tabs 166 of blank 100 such that stacking tabs 166 project upward from blank 100. In the exemplary embodiment, apparatus 400 includes four stacking tab bullets 602 for striking each stacking tab 166 of blank 100 at a predetermined time. In the exemplary embodiment, stacking tab bullets 602 are actuating cylinders that pneumatically transition between an unfired position (not shown) and a fired position (shown in FIG. 6).

Once stacking tabs 166 project from blank 100, side panel rollover arms 604 are engaged to rotate inner side panels 110 and 122 and ledge panels 112 and 120 inward such that panels 110 and 122 capture stacking tabs 166 between panels 110 and 114 and between panels 122 and 118 as described above. Side panel rollover arms 604 then act as a guide to direct blank 100 downstream when pushed by the lug. In the at least partially folded over position, a portion of stacking tabs 166 project outward from ledge panels 112 and 120 and may snag on conventional guiding means. Container forming apparatus 400 employs rollover arms 604 to facilitate guiding blank 100 downstream. Furthermore, blank feeder assembly 600 includes two opposing C-shaped funnel portions 612 to facilitate capture and guidance of blank 100 with partially upwardly rotated inner side panels 110 and 122 to laminating station 408 of forming apparatus 400.

FIG. 7 shows ledge squaring assembly 700 of laminating station 408. In the exemplary embodiment, ledge squaring assembly 700 is immediately downstream of blank feeder assembly 600. Ledge squaring assembly 700 includes a plurality of actuators 702, a mount 704 for the plurality of actuators 702, and at least one ledge squaring arm 706. In the exemplary embodiment, ledge squaring assembly 700 includes two opposing ledge squaring arms 706. Because ledge squaring assembly 700 is located adjacent to blank feeder assembly 600, manipulation of hand wheel 608 along adjustment blocks 610 adjusts the positioning of not only blank feeder assembly 600, but also ledge squaring assembly 700.

FIG. 8 illustrates squaring plate assembly 800, which is positioned above ledge squaring assembly 700 between opposing ledge squaring arms 706. Squaring plate assembly 800 includes an assembly mount 816 for mounting assembly 800 to frame members 402 of forming apparatus 400. Squaring plate assembly 800 also includes a subframe 810 to house adjustment mechanisms, such as hand wheels 812, adjustment rail 814, and adjustment block (not shown). Squaring plate assembly 800 further includes opposing squaring plates 802 that are hingedly coupled to squaring plate mount 806 by hinges 804. Each of opposing squaring plates 802 includes a distal edge 803 opposite hinge 804. Squaring plates 804 are configured to rotate about hinges 804 such that each edge 803 of plates 804 strike container 200 at edges 106 and 108 to facilitate squaring of ledge assemblies 112 and 120. Between opposing squaring plates 802 are guide rails 808 that facilitate directing blank 100 simultaneously under squaring plate assembly 800 and between opposing ledge squaring arms 706 of ledge squaring assembly 700.

FIG. 9 shows laminating assembly 900, a portion of which is positioned on either side of squaring plate assembly 800 and above ledge squaring assembly 700. Laminating assembly 900 includes two laminating plates 902, two laminating arms 904, and two pluralities of actuators 906 mounted to an actuator mount 908. Laminating assembly 900 further includes ratchet 910, adjustment block 912 and adjustment rail 914 that may employed to accommodate forming various containers from various blanks.

In the exemplary embodiment, ledge squaring assembly 700, squaring plate assembly 800, and laminating assembly 900 combine to comprise laminating station 408 of container forming apparatus 400. Assemblies 700, 800, and 900 operate conjunctively to laminate blank 100 in preparation for forming by compression station 410. Specifically, ledge squaring assembly 700 works with squaring plate assembly 800 to properly square ledge panels 112 and 120 with respect to inner side panels 110 and 122 and outer side panels 114 and 118. Laminating assembly 900 then laminates, or seals, panel 110 to panel 114 to form side wall 204 and laminates panel 122 to panel 118 to form side wall 206.

Once blank 100 is directed through funnels 612 of blank feeder assembly 600, the pusher lug positions blank 100 under squaring plate assembly 800 and between portions of ledge squaring assembly 700 and laminating assembly 900. To form the ledges that give thickness to walls 204, 206, 212, 214, 216, 218, and end assemblies 224, actuators 702 fire ledge squaring arms 706 to push inward on blank 100 such that ledges 112 and 120 rotate upward and are squared substantially perpendicularly to outer side panels 114 and 118. Simultaneously, squaring plates 802 of squaring plate assembly 800 fire outward to pivot about hinges 804 and strike first and second edges 106 and 108 of blank 100. The push from ledge squaring arm 706 causes inner side panels 110 and 122 to rotate inward, and squaring plates 802, specifically, squaring plate edges 803, prevent edges 106 and 108 from over-rotating to ensure proper squaring of ledge panels 112 and 120. Squaring plates 802 position edges 106 and 108 flush with fold line 128 such that ledge panels 112 and 120 are square.

When ledge panels 112 and 120 are square and edges 106 and 108 are substantially flush with fold line 128, actuators 906 of laminating assembly 900 fire to form side walls 206 and 204, corner walls 212, 214, 216, and 218, and end assemblies 224. Specifically, laminating plates 902 force inner side panels 110 and 122 into a face-to-face relationship with outer side panels 114 and 118, respectively, at which point laminating arm 904 seals the panels together to form walls 204, 206, 212, 214, 216, 218, and end assemblies 224. Such lamination may be facilitated by an adhesive as described above applied to blank 100 prior to laminating.

FIG. 10 illustrates mandrel assembly 1000 in compression station 410 of container forming apparatus 400. A mandrel drive 1016 is coupled to a main body 1018 of mandrel assembly 1000 to facilitate transition between a first position proximate to blank 100 and a second position where mandrel assembly 1000 is biased against blank 100 for driving blank 100 downward through the compression assembly (shown in FIG. 11-13). In the exemplary embodiment, mandrel drive 1016 is a compression shaft operated by a servo-controlled machine. Mandrel assembly 1000 includes opposing spring-loaded side plates 1002, having bottom edges 1003, coupled to mandrel main body 1018 via hinges 1004. Each end of mandrel main body 1018 includes two end compression plates 1006. Each end compression plate 1006 includes an end face 1008 configured to form at least a portion of end walls 208 and 210 and a miter corner face 1010 configured to form one of corner walls 212, 214, 216, and 218. Servo-driven mandrel assembly 1000 further includes an actuator 1012 and an actuator mount 1014 coupled to each end compression plate 1006. In the exemplary embodiment of container forming apparatus 400, mandrel assembly 1000 includes four end compression plates 1006 and four actuators 1012 such that each actuator 1012 is configured to outwardly fire an end compression plate 1006. Furthermore, actuators 1012 are positioned at an oblique angle with respect to side faces 1002 and end plates 1006. Specifically, actuators 1012 are positioned at a 45 degree angle with respect to side faces 1002 and end plates 1006 to facilitate corner wall 212, 214, 216, and 218 formation by miter corner faces 1010 upon firing of end plates 1006 by actuators 1012.

FIGS. 11-13 show compression assembly 1100 when container 200 is formed from laminated blank 100. In the exemplary embodiment, compression assembly 1100 includes a plurality of side wall forming plates 1102 configured to form side walls 204 and 206 and also includes at least two end wall forming plates 1104 configured to form end walls 208 and 210. Compression assembly 1100 further includes four corner forming bars or plows 1106 configured to facilitate formation of corner walls 212, 214, 216, and 218. Alternatively, container forming apparatus 400 may include any number of forming plates and bars required to facilitates operation as described herein. It will be understood that various blanks require different configurations of forming plates and bars, and that container forming apparatus 400 is adaptable to receive varying configurations of forming plates and bars.

As shown in FIG. 11, compression assembly also includes a plurality of tapering fingers 1108 coupled to compression assembly 1100 via a tapering finger mount 1112. In the exemplary embodiment, compression assembly 1100 includes four tapering fingers 1108 that are spring-loaded by springs 1110 such that, as mandrel assembly 1000 drives blanks through plates 1102 and 1104, tapering fingers 1108 facilitate formation of corner walls 212, 214, 216, and 218 and tapering of side walls 204 and 206 as described in further detail below. Furthermore, compression assembly 1100 includes a plurality of adjustment blocks 1118 and adjustment rails 1116 that may be manipulated such that compression assembly 1100 may be modified to accommodate various sized blanks.

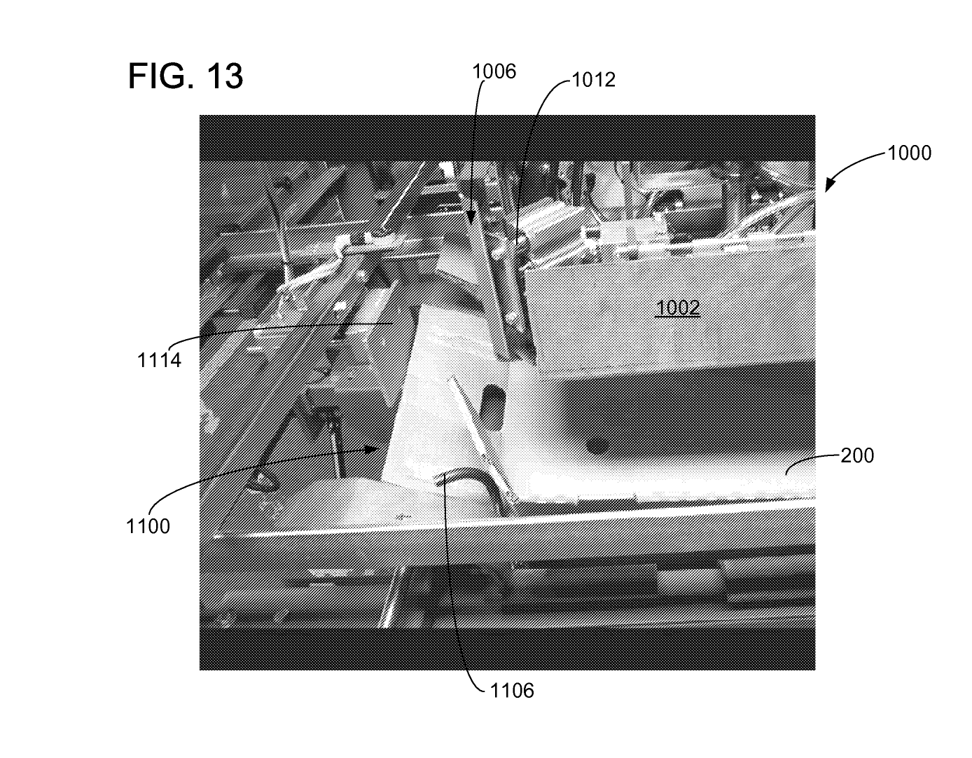

As shown in FIG. 12, compression assembly 1100 further includes a set of rollers 1120 configured to receive laminated blank 100 from lamination station 408 and direct blank 100 downstream in the direction of arrow 412 (shown in FIG. 4) into compression station 410. Pusher lug 1122 is configured to push blank 100 downstream within forming apparatus from hopper station 406, through laminating station 408, and up to compression station 410, where rollers 1120 propel blank 100 into compression station 410. Compression assembly 1100 also includes a stopping plate 1114 (shown in FIG. 13) and stopping fingers 1124 that are configured to properly position laminated blank within compression station 410.

As lug 1122 transports laminated blank 100 from laminating station 408 to compression station 410, rollers 1120 receive blank 100 and drive it downstream under stopping fingers 1124 toward mandrel assembly 1000. Blank 100 impinges upon stopping plate 1114 and stopping fingers 1124 drop after blank 100 passes underneath to prevent blank 100 from rebounding off of stopping plate 1114. Accordingly, laminated blank 100 is positioned underneath mandrel assembly 1000, between stopping plate 1114 and stopping fingers 1124, and above forming plates and bars 1102, 1104, and 1106. Once blank 100 is positioned within compression assembly 1100, the servo motor of mandrel assembly 1000 drives mandrel drive 1016, and therefore mandrel main body 1018, downward and into contact generally with bottom panel 116. Mandrel assembly 1000 drives bottom panel 116 downward a predetermined distance between forming plates 1102 and 1104 and forming bars 1106.

As mandrel assembly 1000 pushes the partially formed container 200 (also described as blank 100) downward through compression assembly 1100, end panels 136 and 140 contact end forming plates 1104 and are rotated about fold lines 138 and 142, respectively, toward end face 1008 of end compression plates 1006. Also, exterior surface 104 of outer side panels 114 and 118 (also described as side walls 204 and 206) contact side forming plates 1102 and are rotated about fold lines 128 and 130, respectively, toward spring-loaded side face 1002. Moreover, each corner panel 148 (also described as corner walls 212, 214, 216, and 218) contacts a corner forming bar 1106 and is rotated about fold line 150 toward miter corner face 1010 of end compression plates 1006.

Mandrel side face 1002 is spring-loaded to facilitate correcting any imperfections which may have occurred in positioning of blank 100 for forming. The spring-loading feature of side face 1002 also allows for the forming of various containers from blanks other than blank 100 without the need to replace mandrel body 1018. Edges 1003 of side faces 1002 contact blank 100 along fold lines 138 and 142 such that side faces 1002 press panels 110 and 114 and panels 122 and 118 against side forming plates 1102 to form side walls 204 and 206 during forming.

When partially formed container 200 is contained within forming plates 1102 and 1104 and forming bars 1106, actuators 1012 of mandrel assembly 1000 fire to extend end compression plates 1006 outward toward end forming plates 1104 and corner forming bars 1106. Actuators 1012 are operable to extend end compression plates 1006 from a retracted first position (shown in FIG. 12) to an extended second position (shown in FIG. 13). The extension of actuators 1012 occurs when mandrel assembly 1000 is contained within forming plates 1102 and 1104 and is shown in the extended position in FIG. 13 for demonstrative purposes only. When actuators 1012 actuate end compression plates 1006, each end face 1008 contacts an inner end assembly 224 of partially formed container 200 and pushes end assemblies 224 against end panels 136 and 140 to form end walls 208 and 210 between end faces 1008 and end forming plates 1104. Simultaneously, miter corner face 1010 contacts corner portion 158 and pushes corner portion 158 against corner panels 148 to form corner walls 212, 214, 216, and 218 between miter corner faces 1010 and corner forming bar 1106. Specifically, as corner forming bars 1106 rotate corner panels 148 about fold line 150, miter corner face 1010 strikes corner panels 148 such that end assemblies 224 rotate about fold lines 154 and corner walls 212, 214, 216, and 218 are formed.

To facilitate formation of corner walls 212, 214, 216, and 218 and tapering of side walls 204 and 206, spring-loaded tapering fingers 1108 contact outer side panels 114 and 118 proximate to fold lines 150 and push panels 114 and 118 inward against side face 1002 as mandrel assembly 1000 is driven through compression assembly 1100. Spring-loaded side face 1002 and spring-loaded tapering fingers 1108 are configured to taper side walls 204 and 206 to approximately match a tapering angle 1020 of side face 1002 (as shown in FIG. 10). Once container 200 is formed by mandrel assembly 1000 within compression assembly 1100, container forming apparatus 400 ejects the completed container.

Exemplary embodiments of containers formed from blanks and adjustable apparatus for making the same are described above in detail. The container, blank, and apparatus are not limited to the specific embodiments described herein, but rather, components of the blanks, containers, and/or apparatus may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus for forming a container, said apparatus comprising:
a hopper station comprising:
a hopper assembly configured to store a plurality of blanks and retrieve a single blank from the plurality of blanks; and
a blank feeder assembly comprising a plurality of tab bullets each configured to fold a respective stacking tab of the blank;
a laminating station downstream from said hopper station and configured to laminate at least a portion of the container; and
a compression station downstream from said laminating station, said compression station configured to form at least one corner wall of the container.

2. An apparatus in accordance with claim 1, wherein said blank feeder assembly further comprises at least one rollover arm configured to at least partially fold a side panel of the blank.

3. An apparatus in accordance with claim 1, wherein said blank feeder assembly further comprises two opposing C-shaped funnel portions configured to capture and guide the blank to said laminating station.

4. An apparatus in accordance with claim 1, wherein said laminating station comprises:
a ledge squaring assembly including at least one squaring arm configured to square a ledge panel of said blank;
a squaring plate assembly including at least one squaring plate configured to square the ledge panel; and
a laminating assembly including at least one laminating plate and at least one laminating arm configured to seal at least a portion of the blank.

5. An apparatus in accordance with claim 1, wherein said compression station comprises a mandrel assembly comprising a plurality of end compression plates, wherein each end compression plate includes a miter corner face configured to form a corner wall of the container.

6. An apparatus in accordance with claim 5, wherein said mandrel assembly further comprises a spring-loaded side face.

7. An apparatus in accordance with claim 1, wherein said compression station comprises a compression assembly comprising a plurality of corner forming bars, wherein each corner forming bar is configured to form a corner wall of the container.

8. An apparatus in accordance with claim 7, wherein said compression assembly further comprises a plurality of tapering fingers configured to taper two opposing side walls of the container.

9. An apparatus in accordance with claim 1, further comprising a pusher lug configured to transport the blank through said apparatus.

10. An apparatus in accordance with claim 1, wherein said hopper assembly comprises at least one vacuum cup configured to retrieve the single blank.

11. A method for forming a container, said method comprising:
transporting a blank through a container forming apparatus using a pusher lug;
folding at least one stacking tab in a blank feeder assembly using at least one tab bullet;
laminating at least a portion of the blank in a laminating assembly; and
compressing the blank using a mandrel assembly.

12. A method in accordance with claim 11, further comprising retrieving the blank from a hopper assembly.

13. A method in accordance with claim 12, wherein retrieving the blank comprises retrieving the blank using at least one vacuum cup.

14. A method in accordance with claim 11, further comprising at least partially folding a side panel of the blank in the blank feeder assembly using a rollover arm.

15. A method in accordance with claim 14, further comprising guiding the blank downstream using the rollover arm.

16. A method in accordance with claim 11, further comprising forming a ledge panel in a ledge squaring assembly using a ledge squaring arm and a squaring plate.

17. A method in accordance with claim 11, wherein laminating at least a portion of the blank comprises laminating at least a portion of the bank using a laminating plate and a laminating arm in the laminating assembly.

18. A method in accordance with claim 11, wherein compressing the blank comprises driving the blank through a compression assembly using the mandrel assembly, the compression assembly having a plurality of forming plates to form the container.

19. A method in accordance with claim 11, further comprising using two opposing C-shaped funnel portions to guide the blank from the blank feeder assembly into the laminating assembly.

20. A method in accordance with claim 11, further comprising manipulating a hand wheel to adjust a position of the blank feeder assembly.
